(19) United States
(12) Patent Application Publication
(10) Pub. No.: US 2026/0086442 A1
(43) Pub. Date: Mar. 26, 2026

(54) SINGLE, SUPPORT ARMATURE CAMERA TOWER INCLUDING POSITIONAL ADJUSTMENT ASSEMBLIES

(71) Applicant: Idemia Identity & Security USA LLC, Reston, VA (US)

(72) Inventors: Harshad R. Thacore, Bedford, MA (US); Brian Bresnahan, Waltham, MA (US); Yasmin Nabavi, Anaheim, CA (US); Etim Nduonyi, Eden Prairie, MN (US); Jonathan Michael Mort, Fort Wayne, IN (US); Derek Riemer, Westford, MA (US); Amy Potts, Westford, MA (US)

(21) Appl. No.: 18/892,172

(22) Filed: Sep. 20, 2024

(51) Int. Cl. G03B 17/56; F16M 11/04; F16M 11/10

(52) U.S. Cl. CPC G03B 17/561; F16M 11/046; F16M 11/10

(57) ABSTRACT

an outer shell surrounding at least a portion of a camera, where the outer shell includes an aperture formed therethrough. The camera housing also includes a positional adjustment assembly coupled to the outer shell. The positional adjustment assembly includes a hub component extending through the aperture of the outer shell, and a tilt plate coupled to and positioned adjacent a first end of the hub component. The tilt plate can include at least one tilt feature. Additionally, the positional adjustment assembly includes an adjustment component coupled to the hub component, between the first end and a second end of the hub component. The adjustment component is selectively adjustable between a locked position and an unlocked position. The positional adjustment assembly of the camera housing is configured to adjust a height and/or an angular tilt of the outer shell in response to the adjustment component being in the unlocked position.

### FIELD

The field of the disclosure relates generally to camera tower systems and more specifically, to single, support armature camera towers that include positional adjustment assemblies for adjusting both the height and angular tilt of a camera for the camera tower.

### BACKGROUND

Previous approaches to camera housings have typically involved fixed structures that do not allow for easy adjustment of the camera's position or orientation. These fixed structures often limit the user's ability to customize the camera's angle or height, resulting in restricted flexibility in capturing desired images or videos.

Some camera housings have incorporated limited adjustment mechanisms, such as manual screws or knobs, to allow for minor changes in the camera's position. However, these mechanisms are often cumbersome to operate and do not provide a wide range of adjustment options.

In certain instances, camera housings have utilized complex mechanical systems involving multiple moving parts to enable adjustments in height or tilt angle. These conventional systems have included gears, levers, and/or motors to facilitate precise positioning of the camera. While these mechanisms offer increased adjustability, they are often bulky, expensive to manufacture, and prone to mechanical failures over time. Additionally, the complexity of these systems may require specialized knowledge or tools for installation and operation, limiting their practicality for everyday users.

Other camera housings have attempted to address the limitations of fixed structures by incorporating a plurality of brackets or armatures that allow for some degree of adjustment. However, these solutions are often limited in their range of motion and may not provide sufficient stability or precision in adjusting the camera's position. Furthermore, the additional components required for these mounting systems can add bulk and weight to the overall camera setup, potentially impacting portability and ease of use.

### BRIEF DESCRIPTION

One aspect includes an outer shell surrounding at least a portion of a camera, where the outer shell includes an aperture formed therethrough. The camera housing also includes a positional adjustment assembly coupled to the outer shell. The positional adjustment assembly includes a hub component extending through the aperture of the outer shell, and a tilt plate coupled to and positioned adjacent a first end of the hub component. The tilt plate can include at least one tilt feature. Additionally, the positional adjustment assembly includes an adjustment component coupled to the hub component, between the first end and a second end of the hub component. The adjustment component is selectively adjustable between a locked position and an unlocked position. The positional adjustment assembly of the camera housing is configured to adjust a height and/or an angular tilt of the outer shell in response to the adjustment component being in the unlocked position.

Another aspect includes a camera mount assembly including a single, support armature including a slot formed through at least a portion of a sidewall, and a slidable mount disposed within the single, support armature. The slidable mount includes a coupling portion extending through the slot of the single, support armature. The camera mount assembly also includes a chain coupled to the slidable mount and extending through the single, support armature. Additionally, the camera mount assembly includes a camera housing coupled to the slidable mount, adjacent the single, support armature. The camera housing includes an outer shell surrounding at least a portion of a camera. The outer shell includes an aperture formed therethrough and is aligned with the coupling portion of the slidable mount. The camera housing also includes a positional adjustment assembly coupled to the outer shell. The positional adjustment assembly includes an adjustment component positioned adjacent the single support armature and selectively adjustable between a locked position and an unlocked position. The positional adjustment assembly is configured to adjust at least one of a height or an angular tilt of the outer shell in response to the adjustment component being in the unlocked position.

An additional aspect includes a camera tower includes a base assembly including a bottom plate, and a camera mount assembly coupled to the base assembly. The camera mount assembly includes a single, support armature extending from the base assembly, where the single, support armature includes a slot formed through at least a portion of a sidewall. The camera mount assembly also includes a slidable mount disposed within the single, support armature, where the slidable mount includes a coupling portion extending through the slot of the single, support armature. The camera mount assembly also includes a chain coupled to the slidable mount and extending through the single, support armature. Additionally, the camera mount assembly includes a camera housing coupled to the slidable mount, adjacent the single, support armature. The camera housing includes an outer shell surrounding at least a portion of a camera. The outer shell includes an aperture formed therethrough and is aligned with the coupling portion of the slidable mount. The camera housing also includes a positional adjustment assembly coupled to the outer shell. The positional adjustment assembly includes an adjustment component positioned adjacent the single support armature and selectively adjustable between a locked position and an unlocked position. The positional adjustment assembly is configured to adjust at least one of a height or an angular tilt of the outer shell in response to the adjustment component being in the unlocked position.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a perspective view of a camera tower including a camera mount assembly;

FIGS. 1B and 1C are partially exploded, perspective views of the camera tower of FIG. 1A;

FIG. 1D is a cross-sectional, perspective view of a portion of the camera tower taken along line 1D-1D in FIG. 1A;

FIG. 1E is a cross-sectional, side view of a portion of the camera tower taken along line 1E-1E in FIG. 1A;

FIG. 2A is an exploded, perspective view of a portion of the camera mount assembly for the camera tower of FIG. 1A;

FIG. 2B is an exploded, perspective view of a positional adjustment assembly included in the camera mount assembly of FIG. 2A;

FIG. 2C is a cross-sectional, back view of a portion of the camera mount assembly taken along line 2C-2C in FIG. 1A;

FIG. 3 is back view of a portion of the camera tower of FIG. 1A; and

FIG. 4 is a front view of a tilt plate for a positional adjustment assembly.

### DETAILED DESCRIPTION

The disclosed assemblies, apparatuses, and systems provide for improved image capturing, accessibility, and adjustability for camera towers. These assemblies, apparatuses, and systems may be implemented in locations where images are regularly and repeatedly captured but require constant operational adjustments due to environmental circumstances (e.g., height of image subject, size of image subject, distance from camera, etc.), such as at security checkpoints (airports, border crossings, government buildings, etc.) and/or official government Identification facilities (e.g., department of motor vehicles, passport photograph sites, etc.).

It should be understood that any values and thresholds described herein may be different in various implementations of assisted enrollment proctoring system, or even in different instances of the process performed by a same assisted enrollment proctoring system. Although discussed herein with reference to assisted enrollment, it is to be understood that the systems may be utilized by self-enrollment proctoring systems. The example values, thresholds, and computations provided herein may optimize the precision and accuracy of any determinations and may further optimize the computational loading of the processor on which the module is implemented, but the disclosed systems and methods may operate with various other parameters without departing from the scope of the disclosure. The examples that follow, with respect to the figures, are illustrative and should not be construed in a limiting manner.

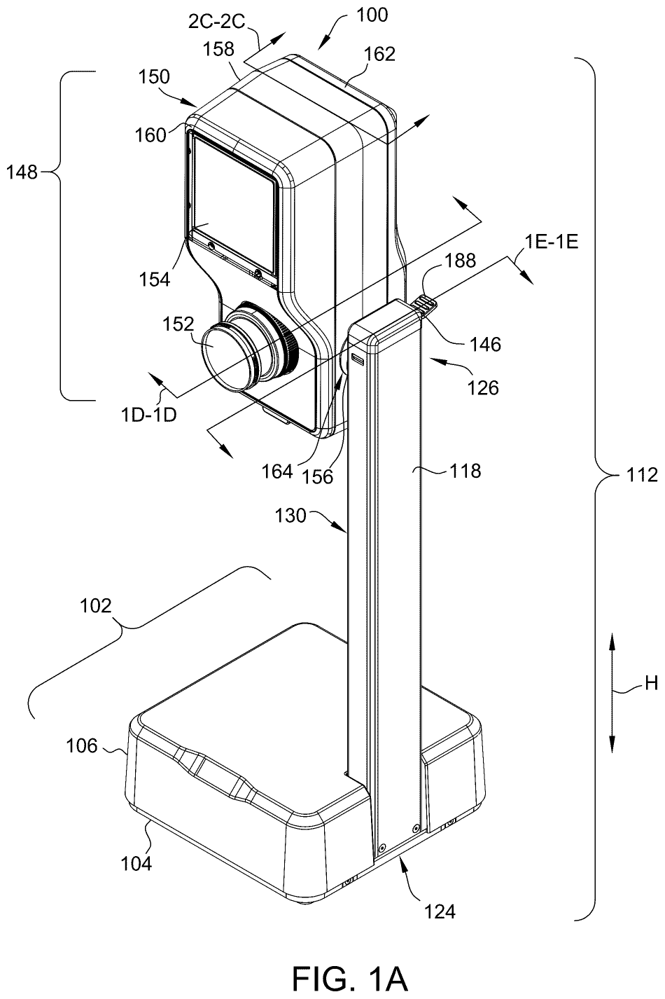

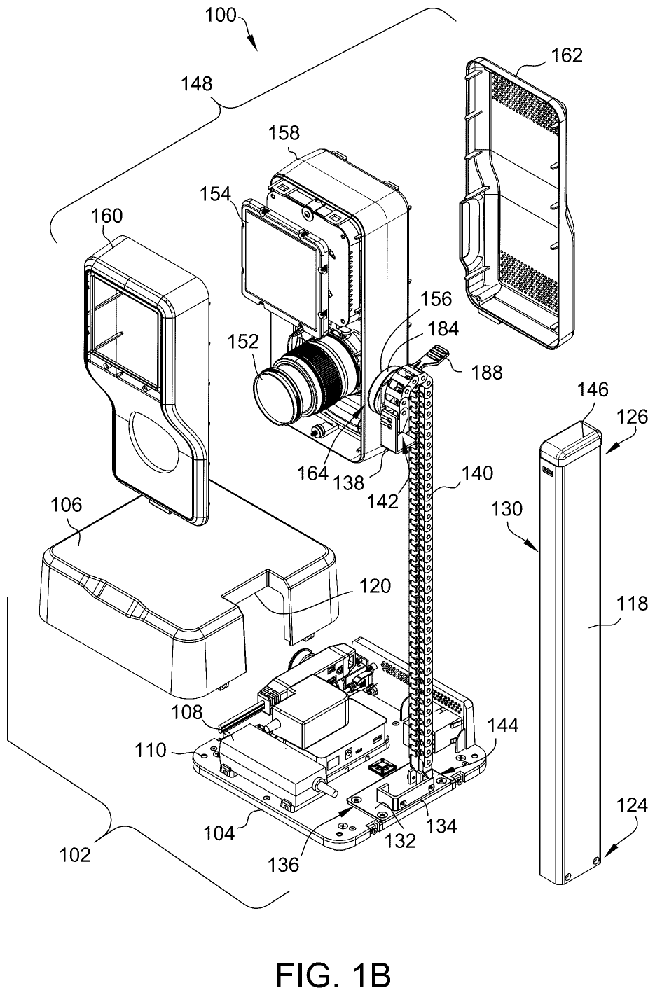

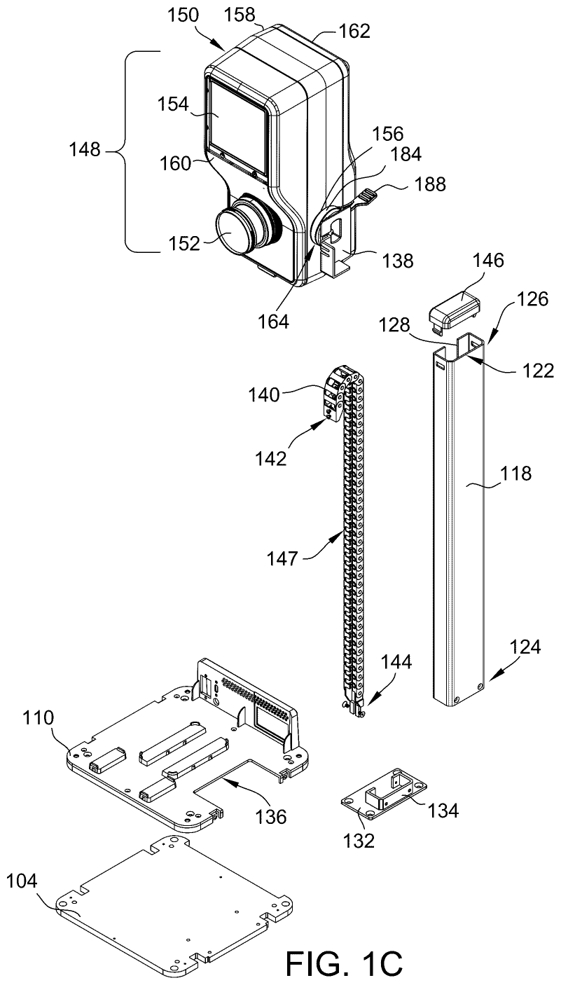

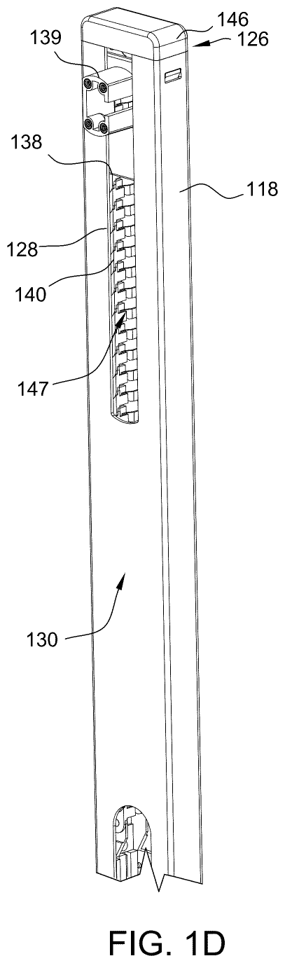

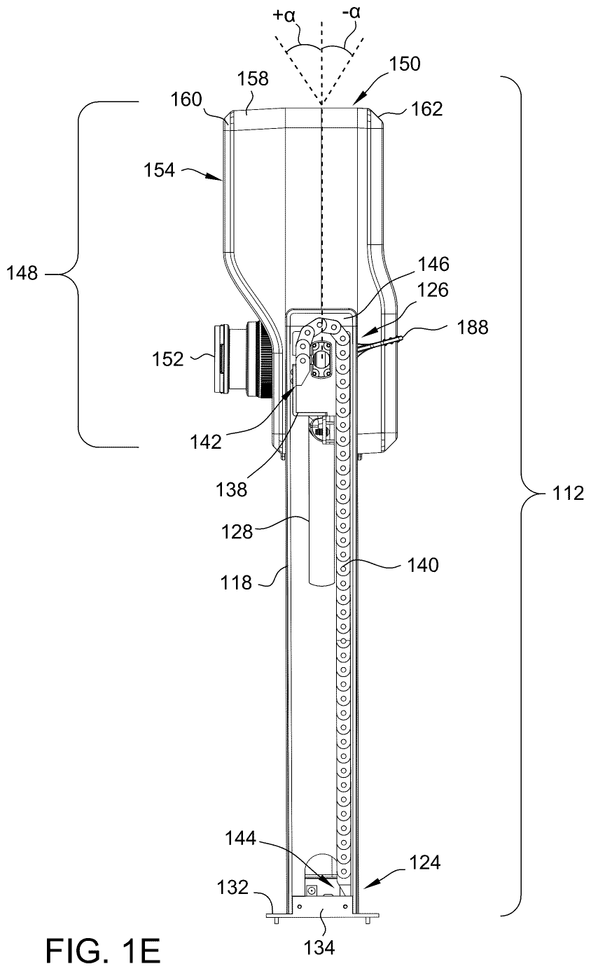

FIGS. 1A, 1B, 1C, 1D, and 1E show various views of a camera tower or camera tower system 100 (hereafter, “camera tower 100”). Specifically, FIG. 1A is a perspective view of camera tower 100 and FIGS. 1B and 1C are partially exploded, perspective views of camera tower 100. Additionally, FIG. 1D is a cross-sectional, perspective view of a portion of camera tower 100 taken along line 1D-1D in FIG. 1A, while FIG. 1E is a cross-sectional, side view of a portion of camera tower 100 taken along line 1E-1E in FIG. 1A. As discussed herein, portions of camera tower 100 are adjustable to alter the height and/or angular tilt of a camera for improving picture capturing capabilities, while reducing an overall footprint of camera tower 100.

Camera tower 100 includes a base assembly 102. Base assembly 102 provides support and stabilizes camera tower 100 during operation. In non-limiting examples shown in FIGS. 1A-1C, base assembly 102 includes a bottom plate 104 positioned adjacent a surface (not shown) in which camera tower 100 is positioned on and/or over, and a cover 106 coupled to bottom plate 104. Bottom plate 104 is formed from any suitable material and/or component configured to support various components of camera tower 100 and/or provide stability to camera tower 100 during operation. For example, bottom plate 104 is formed from a material including, but not limited to, metal, metal alloy, polymer, ceramic material, or the like.

Cover 106 is coupled to and/or positioned over or on bottom plate 104 to define a space between bottom plate 104 and cover 106 of base assembly 102. The space defined between cover 106 and bottom plate 104 can house and/or receive a plurality of components of camera tower 100. For example, and as shown in FIG. 1B, a plurality of electronic components 108 are positioned between bottom plate 104 and cover 106. More specifically, the plurality of electronic components 108 are disposed over and/or coupled to a substrate 110 coupled to and/or positioned on bottom plate 104, opposite cover 106. During operation of camera tower the plurality of electronic components 108 are substantially covered, enveloped, and/or protected by cover 106. The plurality of electronic components 108 of camera tower 100 can be formed as any suitable components to aid in the operation of camera tower 100. For example, the plurality of electronic components 108 can include, but are not limited to, a power supply or power converter, a memory device for storing images captured by a camera of camera tower 100, a device connection hub or multiport (e.g., universal serial bus (USB)), and similar electronic components. In exemplary embodiments, the device connection hub includes a plurality of USB and/or USB type-C ports for connecting a plurality of devices to camera tower 100.

In exemplary embodiments shown in FIGS. 1A-1C and 1E, camera tower 100 also includes a camera mount assembly 112 coupled to base assembly 102. Camera mount assembly 112 includes a single, support armature 118 extending from base assembly 102. More specifically, camera mount assembly 112 includes a single, support armature 118 extending substantially perpendicular from and/or releasably coupled to bottom plate 104 of base assembly 102. As shown in FIGS. 1A and 1B, cover 106 of base assembly 102 includes a recess 120 for receiving and/or being disposed around at least a portion of single, support armature 118 when single, support armature 118 is coupled to and/or extending from base assembly 102. Single, support armature 118 is formed from any suitable material that is capable of supporting distinct components of camera mount assembly 112 for camera tower 100. For example, single support armature 118 is formed from a material including, but not limited to, metal, metal alloy, polymer, ceramic material, or the like.

Single, support armature 118 of camera mount assembly 112 includes an opening 122 extending therethrough. That is, and in exemplary embodiments where single, support armature 118 is formed as a substantially tubular component, single, support armature 118 includes opening 122 extending therethrough and/or extending between a first end 124 and a second end 126 of single, support armature 118. Opening 122 formed in single, support armature 118 is configured to receive various components of camera tower 100, as discussed herein. Additionally, single, support armature 118 also includes a slot 128 formed in a sidewall 130. More specifically, and as shown in FIG. 1C, slot 128 is formed through at least a portion of sidewall 130 adjacent second end 126 of single, support armature 118. As discussed herein, slot 128 receives a distinct component of camera mount assembly 112 to facilitate the positional adjustment and/or movement of distinct portions of camera tower 100 during operation.

In exemplary embodiments, camera mount assembly 112 also includes a support plate 132 coupled to single, support armature 118. Support plate 132 is releasably coupled to first end 124 of single, support armature 118, opposite second end 126 and/or slot 128 formed through at least a portion of sidewall 130. For example, and as shown in FIGS. 1B and 1C, first end 124 of single, support armature 118 is releasably coupled and/or affixed to a bracket 134 included on and/or formed integral with support plate 132. Additionally, support plate 132 is releasably coupled to and/or positioned on bottom plate 104 of base assembly 102. In the non-limiting example shown in FIGS. 1B and 1C, support plate 132 is positioned within, received by, and/or adjacent to a notch 136 formed in substrate 110 to facilitate the releasable coupling of support plate 132 directly to substrate 110 of base assembly 102. As discussed herein, releasably coupling support plate 132 to bottom plate 104 facilitates the complete assembling of camera mount assembly 112 separate from base assembly 102 and/or increases the ability to perform maintenance on different components of camera mount assembly 112 by uncoupling support plate 132 from bottom plate 104. Support plate 132 is releasably coupled to bottom plate 104 of base assembly 102 using any suitable coupling technique and/or mechanism. Additionally, single, support armature 118 is releasably coupled to bracket 134 of support plate 132 using any suitable coupling technique and/or coupling mechanism including, but not limited to, screws, nuts-and-bolts, snap fits, pins, and the like.

Camera mount assembly 112 further includes a slidable mount 138 disposed within said single, support armature 118. For example, and as discussed herein, slidable mount 138 is disposed within and/or positioned inside of opening 122 of support armature 118. Slidable mount 138 is also positioned adjacent to and/or substantially aligned with slot 128 formed through sidewall 130, adjacent second end 126 of single, support armature 118. As shown in FIG. 1D, slidable mount 138 includes a coupling portion 139 that extends through slot 128 of single, support armature 118 to facilitate the coupling of various components of camera mount assembly 112. That is, and as discussed herein, coupling portion 139 of slidable mount 138 extends through slot 128, adjacent to and/or outside of opening 122 of single, support armature 118, and is configured to be coupled to distinct components (e.g., positional adjustment assembly) of camera mount assembly 112.

Additionally, and as discussed herein, slidable mount 138 is configured to move within opening 122 of single, support armature 118 to adjusting the height (H) of distinct components of camera mount assembly 112 relative to base assembly 102. Coupling portion 139 of slidable mount 138 is also configured to selectively move within slot 128 of single, support armature 118 when adjusting the height (H) of distinct components of camera mount assembly 112. In the non-limiting example shown in FIG. 1D, and as discussed herein, slot 128 is formed through a portion of sidewall 130 and/or does not extend through sidewall 130 adjacent second end 126. As a result of coupling portion 139 extending through slot 128, the length or size of slot 128 and/or coupling portion 139 extending through slot 128 limits and/or restricts the height range in which components of camera tower 100 are adjusted. In other non-limiting examples, slot 128 can extend through the entire length of single, support armature 118 to provide increased adjustment to the height (H), as discussed herein. To facilitate the sliding of slidable mount 138 within opening 122 of single, support armature 118, slidable mount 138 including coupling portion 139 is formed from any suitable material that includes a low coefficient of friction with single, support armature 118. Additionally, slidable mount 138 is also formed from a substantially rigid material to provide support to various components of camera mount assembly 112, as discussed herein. For example, slidable mount 138 is formed from metal, metal alloys, polymer, ceramic, fibrous material (e.g., fiberglass), and the like.

A chain 140 of camera mount assembly 112 is coupled to slidable mount 138. More specifically, chain 140 is disposed within, extends through, and/or is positioned inside of opening 122 of support armature 118 and is coupled and/or affixed to slidable mount 138. In a non-limiting example shown in FIG. 1B, a first end 142 of chain 140 is coupled directly to slidable mount 138, while a second end 144 of chain 140, opposite first end 142, is coupled and/or affixed to bracket 134 of support plate 132. In other exemplary embodiments, second end 144 of chain 140 is fixed directly to support plate 132 and/or support armature 118, adjacent second end 126. Additionally, and as shown in FIG. 1E, chain 140 is wrapped around, and/or substantially bends around slidable mount 138 within camera tower 100. To facilitate the bending of chain 140, and/or to prevent slidable mount 138 and chain 140 from being removed from support armature 118 during operation, an end cap 146 is coupled to support armature 118. As discussed herein chain 140, and more specifically first end 142 of chain 140, is configured to selectively move within single, support armature 118, in conjunction with slidable mount 138, in response to adjusting the height (H) of distinct components of camera mount assembly 112 relative to base assembly 102. That is, and as a result of first end 142 of chain 140 being coupled directly to slidable mount 138, first end 142, and adjacent portions of chain 140 are configured to selectively move, along with slidable mount 138, within single, support armature 118 when adjusting the height (H) of distinct components of camera mount assembly 112. Chain 140 is formed as energy chain. However, it is understood that chain 140 can be formed from any suitable grouping mechanism and/or device that is configured to move within support armature 118 and/or housing wires for various components of camera tower 100, as discussed herein. Chain 140 is formed from any suitable material and/or component configured to move within support armature 118 during operation. For example, chain 140 is formed from a material including, but not limited to, metal, metal alloy, polymer, ceramic material, braided fibers/fibrous material, or the like.

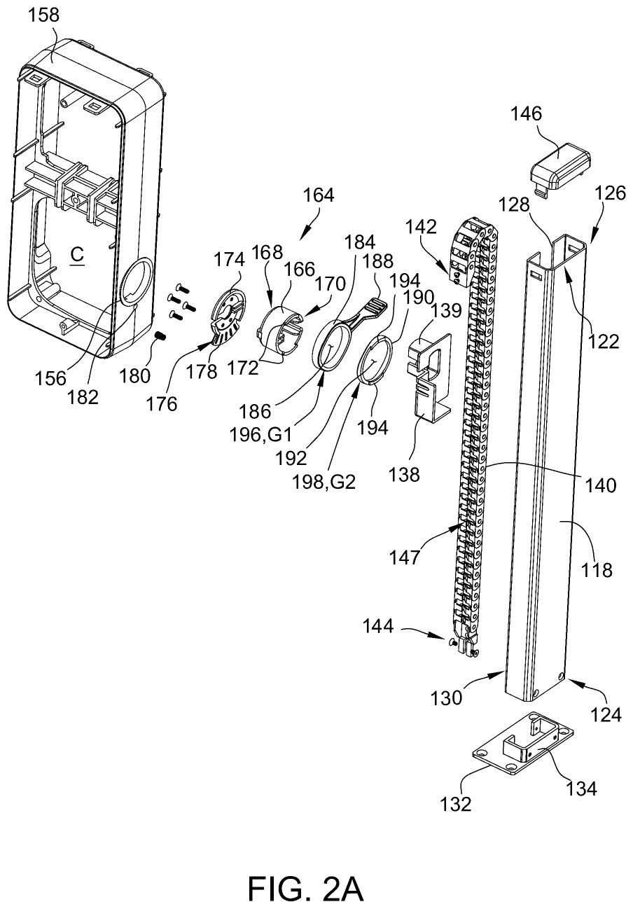

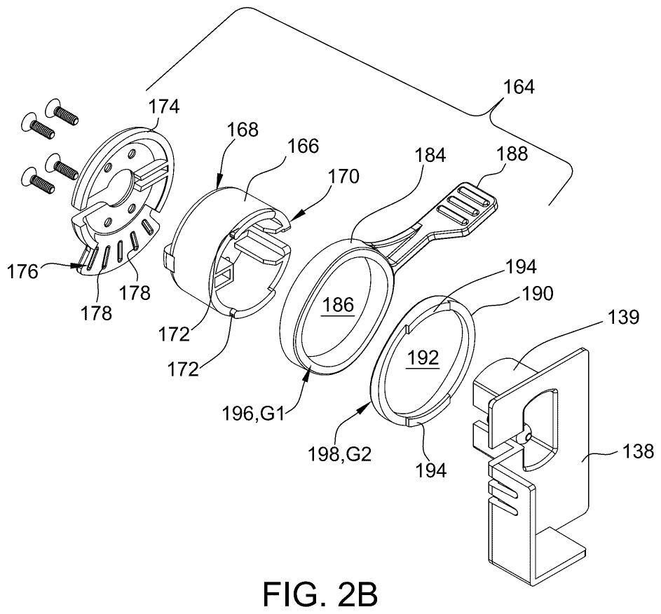

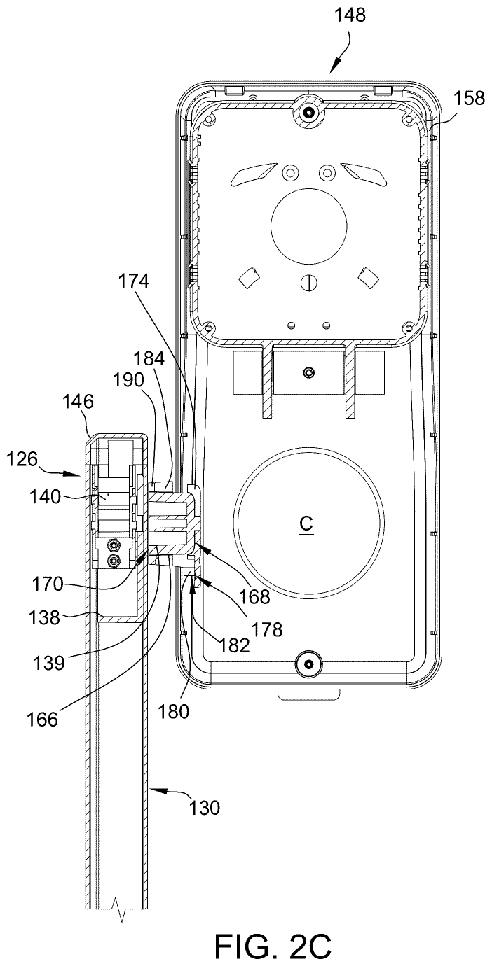

Furthermore, chain 140 is configured to house, protect, and/or restrict movement of wires or physical electrical connections (see, FIG. 2C) for the camera and/or flash component included within camera tower 100. In exemplary embodiments, chain 140 includes a break, discontinuity, and/or “zipper” 147 (hereafter, “break 147”) in a portion of each of the links forming chain 140. Breaks 147 of chain 140 provide access to an internal cavity defined by and/or within each link. For example, and as shown in FIGS. 1C and 1D, breaks 147 are formed on an inner portion of each link for chain 140. Breaks 147 provide improved and/or ease of access to the internal cavity defined by the links of chain 140, such that wires and/or electrical connections coupled to the camera and/or flash component and plurality of electronic components 108 housed in base assembly 102 can be disposed within and/or extend through support armature 118 within chain 140. Additionally, or alternatively, housing the wires of camera tower 100 within chain 140 substantially prevents and/or reduces the risk of the wires obstructing the movement of slidable mount 138 within single, support armature 118 during operation of camera tower 100, as discussed herein.

As shown in FIGS. 1A-1C, camera mount assembly 112 also includes a camera housing 148 coupled to slidable mount 138. Camera housing 148 of camera mount assembly 112 is also positioned adjacent single, support armature 118 of camera tower 100. In exemplary embodiments, camera housing 148 includes an outer shell 150 surrounding, circumscribing, and/or housing at least a portion of a camera 152 and/or a flash device 154, respectively. Outer shell 150 of camera housing 148 includes an aperture 156 formed therethrough. More specifically, and as shown in FIGS. 1B and 1C, outer shell 150 includes a sidewall portion 158 including aperture 156 formed therethrough, where aperture 156 is substantially adjacent to and/or aligned with single, support armature 118. Additionally in the non-limiting example, outer shell 150 of camera housing 148 also includes a front portion 160 releasably coupled to sidewall portion 158, and a back portion 162 releasably coupled to sidewall portion 158, opposite front wall portion 160. Releasably coupling front portion 160 and/or back portion 162 of outer shell 150 provides increased access and/or ease of accessibility to camera 152 and/or flash device 154 to perform maintenance and/or exchange parts of components within camera tower 100 during operation. Outer shell 150 is formed from any suitable material that protects and/or supports camera 152 and/or flash device 154 during operation of camera tower 100.

Camera mount assembly 112 also includes a positional adjustment assembly 164 coupled to outer shell 150 of camera housing 148. As shown in FIGS. 1A-1C, at least a portion of positional adjustment assembly 164 is also positioned between outer shell 150 and single, support armature 118. As discussed herein, positional adjustment assembly 164 is configured to adjust the height (H) of outer shell 150 of camera housing 148 relative to base assembly 102, and/or adjust angular tilt (α) (see, FIG. 1E) relative to single, support armature 118 during operation or use of camera tower 100.

With continued reference to FIGS. 1A-1E, FIGS. 2A, 2B, and 2C show various views of various components of camera tower 100 including positional adjustment assembly 164. More specifically, FIG. 2A shows an exploded, perspective view of a portion of the components forming camera tower 100 including positional adjustment assembly 164, and FIG. 2B shows an exploded, perspective view of slidable mount 138 and positional adjustment assembly 164. Additionally, FIG. 2C is a cross-sectional, back view of a portion of camera tower 100 taken along line 2C-2C in FIG. 1A. FIGS. 2A and 2C omit camera 152 and flash device 154 for the sake of clarity.

Furthermore, it is understood that similarly numbered and/or named components may function in a substantially similar fashion. Redundant explanation of these components has been omitted for clarity.

Positional adjustment assembly 164 of camera housing 148 includes a hub component 166 extending through aperture 156 formed through sidewall portion 158 of outer shell 150. More specifically, and as shown in FIG. 2C, at least a portion of hub component 166 extends through aperture 156 formed through sidewall portion 158, such that a first end 168 of hub component 166 is positioned within body portion 158 and/or substantially adjacent aperture 156. In exemplary embodiments, at least a portion of first end 168 is also positioned within an internal cavity (C) defined by outer shell 150. Additionally, a second end 170 of hub component 166, position opposite first end 168, is positioned outside of and/or adjacent body portion 158 of outer shell 150. Second end 170 of hub component 166 is also positioned adjacent to and/or abuts single, support armature 118. In exemplary embodiments shown in FIGS. 2B and 2C, second end 170 of hub component 166 includes opposing tabs 172 positioned opposing one another. Tabs 172 of hub component 166 are sized and/or configured to be positioned within and/or engage slot 128 formed through sidewall 130 of single, support armature 118. In the exemplary embodiment, positioning, disposing and/or engaging tabs 172 of hub component 166 within slot 128 substantially prevents undesirable rotation of hub component 166, and additional components of positional adjustment assembly 164 coupled thereto, during operation of camera tower 100. Additionally, and as discussed herein, tabs 172 of hub component 166 are disposed, positioned, and/or engaged within slot 128 to guide the movement of various components of camera tower 100 with respect to support armature 118. Although two opposing tabs 172 are shown, it is to be understood that hub component 166 can include more or less tabs 172 for being disposed within slot 128 during operation.

Hub component 166 is formed as a substantially tubular component. In non-limiting examples shown in FIG. 2C, at least a portion of tubular hub component 166 is disposed around, circumscribes, and/or envelops coupling portion 139 of slidable mount 138 when coupling positional adjustment assembly 164 to slidable mount 138. Additionally, and as discussed herein, hub component 166 is releasably coupled to coupling portion 139 of slidable mount 138 within camera mount assembly 112 of camera tower 100. Hub component 166 of positional adjustment assembly 164 is formed from any suitable material that supports the connection and/or coupling of hub component 166 to the various components of camera mount assembly 112/camera housing 148, as discussed herein. For example, hub component 166 is formed from a material including, but not limited to, metal, metal alloy, polymers, ceramics, fibrous materials, and the like.

Positional adjustment assembly 164 also includes a tilt plate 174 coupled to hub component 166. More specifically, and as shown in FIG. 2C, tilt plate 174 is coupled to and positioned adjacent first end 168 of hub component 166. Tilt plate 174 is also positioned and/or disposed within internal cavity (C) defined by outer shell 150 of camera housing 148, adjacent to and substantially aligned with aperture 156 formed through sidewall portion 158. As shown in FIG. 2C, tilt plate 174 also abuts, contacts, and/or is positioned directly adjacent an inner surface of outer shell 150, and more specifically sidewall portion 158 of outer shell 150. In the non-limiting example shown in FIGS. 2A and 2B, a coupling mechanism (e.g., screws) is shown as extending through tilt plate 174 and hub component 166, and in turn coupling tilt plate 174 and hub component 166 to coupling portion 139 of slidable mount 138. More specifically, a plurality of screws pass through, and in turn, couple tilt plate 174, hub component 166, and slidable mount 138 to one another within camera tower 100. In other non-limiting examples, tilt plate 174 can be coupled to hub component 166 independent of slidable mount 138, and vice versa.

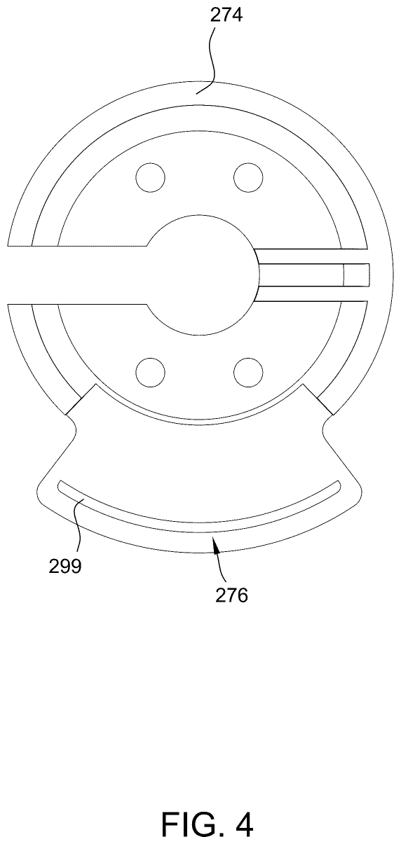

Tilt plate 174 is configured to and/or facilitates the angular tilt of outer shell 150 for camera housing 148. That is, tilt plate 174 includes at least one tilt feature 176 that facilitates adjustment of the angular tilt of outer shell 150 for camera tower 100 during operation. In the non-limiting example shown in FIGS. 2A-2C, tilt feature 176 of tilt plate 174 includes a plurality of fanned notches 178 formed on a surface of tilt plate 174, adjacent to hub component 166. In the exemplary embodiment, tilt plate 174 includes five (5) distinct notches 178 spaced apart and/or oriented with respect to one another such that during operation, the angular tilt for outer shell 150 can be adjusted between +30° and −30°. As such, each adjacent notch 178 may determine, define, and/or distinguish a 15° angular tilt difference for outer shell 150, where the third or middle notch 178 defines and/or positions outer shell 150 in a 0° angular tilt when engaged during operation of camera tower 100. Although five (5) notches 178 are shown, it is understood that tilt plate 174 can include more or less notches forming tilt feature 176 (see, FIG. 4). Similar to hub component 166 of positional adjustment assembly 164, tilt plate 174 is formed from any suitable material that facilitates the adjustment of the angular tilt of camera housing 148, as discussed herein. For example, tilt plate 174 is formed from a material including, but not limited to, metal, metal alloy, polymers, ceramics, fibrous materials, and the like. Additionally, although discussed herein as ranging from +30° and −30° and/or being adjustable by 15° increments, it is understood that the plurality of notches 178 included in tilt plate 174 can be larger, smaller, and/or include a distinct spacing to increase or decrease the angular tilt range achievable by outer shell 150.

To secure and/or maintain the angular tilt (α) (see, FIG. 1E) of outer shell 150 for camera housing 148, camera housing 148 includes additional components to engage and/or interact with tilt plate 174 of positional adjustment assembly 164. For example, and as shown in FIGS. 2A and 2C, camera housing 148 also includes securing component 180 coupled to and/or formed within outer shell 150. More specifically, securing component 180 is positioned within and/or extends through a distinct aperture 182 formed through sidewall portion 158 of outer shell 150. Aperture 182 is positioned below aperture 156 configured to receive hub component 166 of positional adjustment assembly 164. As such, securing component 180 disposed within and/or extending through aperture 182 extends toward tilt plate 174 of hub component 166 and/or is substantially aligned with tilt feature 176 of tilt plate 174. In the exemplary embodiment shown in FIG. 2C, securing component 180 is configured to contact tilt feature 176, and more specifically each of the plurality of fanned notches 178, included in tilt plate 174 to secure and/or maintain outer shell 150 at a desired angular tilt (α) during operation of camera tower 100. Additionally, securing component 180 is also formed as any suitable component, apparatus, and/or device to facilitate the adjustment between distinct angles for the angular tilt (α) of outer shell 150 during operation of camera tower 100. Although discussed herein as being positioned within distinct aperture 182, it is to be understood that securing component 180 can be formed integral with and/or within sidewall portion 158 of outer shell 150.

In non-limiting examples, securing component 180 can include a spring loaded roller ball that is configured to be positioned within and/or engage the plurality of notches 178 included in tilt plate 174. That is, roller ball can be disposed within and/or contact one of the plurality of notches 178 in tilt plate 174 to maintain and/or securing outer shell 150 in a desired angular tilt (α), dependent upon the specific notch 178. Additionally, spring loaded roller ball can be “rolled out of” and/or at least partial compressed to roller over portions of tilt plate 174 formed between each of the plurality of notches 178 to when adjusting the angular tilt (α) of outer shell 150. As discussed herein, a user of camera tower 100 can apply a rotational force to outer shell 150 to adjust the angular tilt (α) using tilt plate 174 and securing component 180, respectively. Additionally, securing component 180, formed as a spring loaded roller ball, also provides tactile feedback (e.g., “Clicks”) to the user as they adjust the angular tilt (α) of outer shell 150 during operation. Although discussed herein as spring-loaded roller ball, securing component 180 can be formed as any suitable device, mechanism, and/or apparatus that is configured to facilitate the adjusting and maintaining of the angular tilt (α) of outer shell 150 during operation of camera tower 100. For example, securing component 180 can be formed as pin and/or screw that engages and/or contacts tilt plate 174 as similarly discussed herein.

Positional adjustment assembly 164 of camera housing 148 also includes an adjustment component 184 coupled to hub component 166. More specifically, adjustment component 184 is coupled to hub component 166 between first end 168 and second end 170, and positioned between and/or adjacent to single, support armature 118 and sidewall portion 158 of outer shell 150. As such, and as shown in FIG. 2C, adjustment component 184 is disposed outside of internal cavity (C) defined by outer shell 150 of camera housing 148 and/or proximate tilt plate 174. Additionally, and as shown in FIGS. 2A-2C, adjustment component 184 includes an opening 186 for receiving, circumferentially surrounding, and/or circumscribing at least a portion of hub component 166, between first end 168 and the second end 170, respectively. As a result of receiving and/or circumscribing hub component 166, adjustment component 184 is configured to rotate about hub component 166 and/or is selectively adjustable between a locked position and an unlocked position during operation of camera tower 100. As discussed herein, in the unlocked positioned, the height (H) and/or angular tilt (α) of outer shell 150 for camera tower 100 can be adjusted by a user. Alternatively, when adjustment component 184 of positional adjustment assembly 164 is in the locked position the height (H) and/or angular tilt (α) of outer shell 150 for camera tower 100 is maintained, locked, and/or unable to be adjusted.

As shown in the exemplary embodiments, adjustment component 184 includes a lever handle portion 188 to aid in the rotation and/or selective adjustment between the locked and unlocked position. However, it is understood that adjustment component 184 can include any distinct feature to aid in the rotation of adjustment component 184 during operation of camera tower 100, as discussed herein. Adjustment component 184 is formed from any suitable material that facilitates the selective adjustment of positional adjustment assembly 164 between the locked and unlocked position, as discussed herein. For example, adjustment component 184 is formed from a material including, but not limited to, metal, metal alloy, polymers, ceramics, fibrous materials, and the like.

In the non-limiting example shown in FIGS. 2A-2C, positional adjustment assembly 164 also includes a cam component 190 coupled to hub component 166. More specifically, cam component 190 is coupled to hub component 166 between first end 168 and second end 170, and positioned between and/or adjacent to single, support armature 118 and adjustment component 184. As such, and as shown in FIG. 2C, cam component 190 is disposed outside of internal cavity (C) defined by outer shell 150 of camera housing 148 and/or directly adjacent second end 170 of hub component 166 and single, support armature 118, respectively. Similar to adjustment component 184, and as shown in FIGS. 2A-2C, cam component 190 includes an opening 192 for receiving, circumferentially surrounding, and/or circumscribing at least a portion of hub component 166, between first end 168 and the second end 170, respectively. However, cam component 190 is not configured to rotate about hub component 166. In the exemplary embodiment, and similar to hub component 166, cam component 190 includes opposing tabs 194 positioned opposing one another. Tabs 194 of cam component 190 are sized and/or configured to be positioned within and/or engage slot 128 formed through sidewall 130 of single, support armature 118. In the exemplary embodiment, positioning, disposing and/or engaging tabs 194 of cam component 190 within slot 128 substantially prevents undesirable rotation of cam component 190 during operation of camera tower 100. Similar to adjustment component 184, cam component 190 is formed from any suitable material including, but not limited to, metal, metal alloy, polymers, ceramics, fibrous materials, and the like.

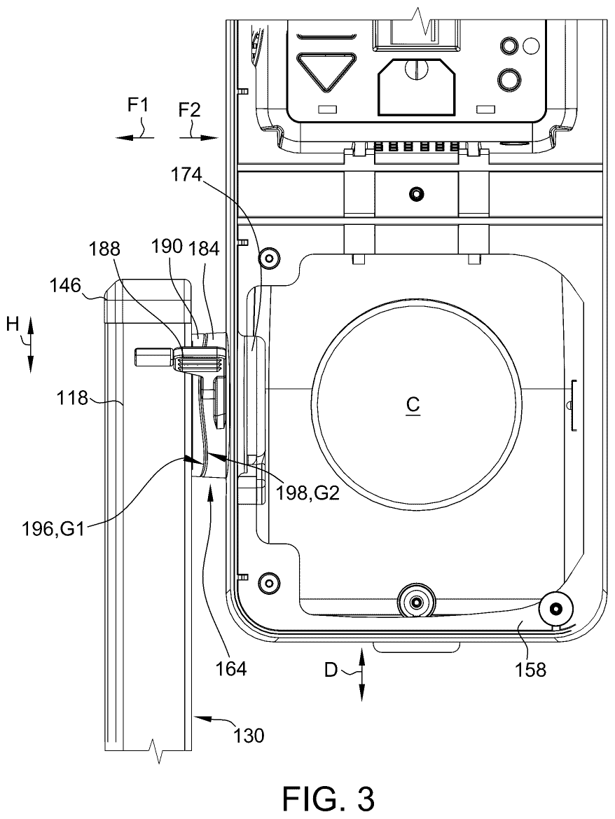

Cam component 190 facilitates the selective adjustment of adjustment component 184 between the locked position and the unlocked position during operation of camera tower 100. That is, the rotational movement of adjustment component 184, and in turn adjustment component's 184 mechanical and/or physical interaction with stationary cam component 190 facilitates positional adjustment assembly 164 being in either the locked position or the unlocked position. For example, and as shown in FIG. 2B, adjustment component 184 includes an end face 196 having a first geometry (G1). Additionally, cam component 190 includes an end face 198 positioned adjacent adjustment component 184 and/or end face 196 of adjustment component 184. End face 198 of cam component 190 includes a second geometry (G2) that is complimentary to the first geometry (G1) of end face 196 for adjustment component 184 in the unlocked position. That is, and as discussed herein (see, FIG. 3), when positional adjustment assembly 164 is in the unlocked position, the end faces 196, 198, and corresponding geometries (G1, G2) for adjustment component 184 and cam component 190 are complementary to facilitate and/or allow adjustments to the height (H) and/or angular tilt (α) of outer shell 150 for camera tower 100. As shown in the non-limiting example, each geometry (G1, G2) of respective faces 196, 198 are formed to include substantially waved/sinusoidal faces or surfaces. However, it is to be understood that the geometries (G1, G2) of respective faces 196, 198 can include any geometrically complimentary features and/or shapes.

As discussed herein, wires (not shown) connected to camera 152 and/or flash device 154 are at least partially housed within chain 140. That is, wires pass through a plurality of concentric and/or partially aligned holes formed in slidable mount 138, hub component 166 and tilt plate 174, respectively, and extend within internal cavity (C) defined by outer shell 150. Wires are mechanically and/or electrically connected to camera 152 and/or flash device 154 within outer shell 150 to provide power and/or transmit data/signals between the plurality of electronic components 108 and camera 152/flash device 154 during operation of camera tower 100.

FIG. 3 is back view of a portion of camera tower 100. FIG. 3 omits camera 152, flash device 154, and back portion 162 of outer shell 150 for the sake of clarity. Furthermore, it is understood that similarly numbered and/or named components may function in a substantially similar fashion. Redundant explanation of these components has been omitted for clarity.

In the exemplary embodiment shown in FIG. 3, and with continued reference to FIGS. 2A-2C, positional adjustment assembly 164 of camera housing 148 is depicted in an unlocked position. More specifically, end face 196 of adjustment component 184 including the first geometry (G1) is substantially aligned with and/or complementary with end face 198 of cam component 190 including the second geometry (G2). In the non-limiting example, a “peak” of the sinusoidal pattern of the second geometry (G2) for end face 198 of cam component 190 is substantially aligned with a “valley” of the complementary sinusoidal pattern of the first geometry (G1) for end face 196 of adjustment component 184. As a result of being in the unlocked position, positional adjustment assembly 164 does not apply a force (F1, F2) against single, support armature 118 and outer shell 150, respectively. As such, a user is free or capable of adjusting the height (H) of outer shell 150 by applying a directional force (D) to outer shell 150 to move slidable mount 138 within single, support armature 118. As a result of camera housing 148, and more specifically positional adjustment assembly 164 being coupled to both slidable mount 138 and outer shell 150, outer shell 150 moves with slidable mount 138 to adjust the height (H).

Additionally, or alternatively, when in the unlocked position, the angular tilt (α)(see, FIG. 1E) of outer shell 150 can also be adjusted. That is, and as a result of no force (F2) being applied to outer shell 150 by positional adjustment assembly 164, and more specifically adjustment component 184 in the unlocked position, a rotational force (e.g., in and out of the page) can be applied to outer shell 150 to adjust the angular tilt (α). As discussed herein, securing component 180 included in sidewall portion 158 of outer shell 150 also facilitates the adjusting and/or maintaining of the angular tilt (α) of outer shell 150 during operation of camera tower 100.

Alternatively in the locked position, positional adjustment assembly 164 imparts or applies a force (F1, F2) against single, support armature 118 and outer shell 150, respectively, to prevent adjustment and/or maintain the height (H) and/or angular tilt (α) of outer shell 150. For example, adjustment component 184 of FIG. 3 is rotated (e.g., into the page) about hub component 166 to selective move or adjust positional adjustment assembly 164 from the unlocked position to the locked position. In response to rotating adjustment component 184 about hub component 166 into the locked position, the geometries (G1, G2) of each end face 196, 198 for adjustment component 184 and cam component 190 are no longer complimentary. More specifically, rotating adjustment component 184 results in a “peak” of the sinusoidal pattern of the first geometry (G1) for end face 196 of adjustment component 184 being substantially aligned with and/or contacting a distinct “peak” of the sinusoidal pattern of the second geometry (G2) for end face 198 of cam component 190. This in turn causes adjustment component 184 and cam component 190 to apply forces (e.g., compressive forces) (F1, F2) against adjacent components of camera tower 100. In the non-limiting example, in the locked position, cam component 190 applies a first force (F1) against sidewall 130 of single, support armature 118. Additionally, adjustment component 184 applies a second force (F2), opposite the first force (F1), against outer shell 150, and more specifically sidewall portion 158, when positional adjustment assembly 164 is in the locked position. The applied forces on single, support armature 118 and outer shell 150 prevent a user from being able to adjust the height (H) and/or angular tilt (α) of outer shell 150, as well as maintain the current height (H) and angular tilt (α) of outer shell 150 when positional adjustment assembly 164 is in the locked position.

It is to be understood that the height (H) and angular tilt (α) of outer shell 150 for camera tower 100 can be adjusted independent of one another. That is, the height (H) of outer shell 150 can be adjusted independent of the angular tilt (α), and vice versa. As such, a user can adjust both the height (H) and angular tilt (α) of outer shell 150, or alternatively can adjust the height (H) or the angular tilt (α) of outer shell 150. Additionally, although discussed herein as only being able to adjust the height (H) and angular tilt (α) of outer shell 150 when positional adjustment assembly 164 is in the unlocked position, it is understood that in other non-limiting examples, the height (H) or angular tilt (α) of outer shell 150 can be adjusted when positional adjustment assembly 164 is in the locked positioned. For example, securing component 180 can be manipulated to adjust the angular tilt (α) of outer shell 150, as similarly discussed herein with respect to FIGS. 2A-2C, regardless of whether positional adjustment assembly 164 is in the locked or unlocked position. In this exemplary embodiment, positional adjustment assembly 164 can only lock and/or secure the height (H) of outer shell 150, while securing component 180 controls, and/or maintains the angular tilt (α) of outer shell 150.

FIG. 4 is a front view of tilt plate 274 for a positional adjustment assembly (not shown) for another non-limiting example of camera tower 100. As similarly discussed herein with respect to FIGS. 2A-2C, tilt plate 274 includes at least one tilt feature 276 that facilitates adjustment of the angular tilt of outer shell 150 for camera tower 100 during operation. In the non-limiting example shown, tilt feature 276 of tilt plate 274 includes a single, curved notch 299 formed on a surface of tilt plate 274. In the exemplary embodiment, curved notch 299 is formed and/or oriented such that during operation, the angular tilt for outer shell 150 can be adjusted between +30° and −30°. As such, each end of single, curved notch 299 angularly offset from one another by approximately 60°. In the non-limiting example shown in FIG. 4, single, curved notch 299 also provides improved and/or an increased number of obtainable angular tilts for outer shell 150. That is, and with comparison to tilt plate 174 (see, FIGS. 2A-2C) which allows for the angular tilt (α) to be adjusted in 15° increments, curved notch 299 provides the user the ability to adjust the angular tilt (α) of outer shell 150 to any angle ranging between +30° and −30°. Although discussed herein as ranging from +30° and −30°, it is understood that single, curved notch 299 can be larger, smaller, and/or include a distinct curvature to increase or decrease the angular tilt range achievable by outer shell 150.

In the foregoing specification and the claims that follow, a number of terms are referenced that have the following meanings.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here, and throughout the specification and claims, range limitations may be combined or interchanged. Such ranges are identified and include all the sub-ranges contained therein unless context or language indicates otherwise.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is generally not intended to imply certain embodiments require at least one of X, at least one of Y, and at least one of Z to each be present. Additionally, conjunctive language such as the phrase “at least one of X, Y, and Z,” unless specifically stated otherwise, should be understood to mean any combination of at least one of X, at least one of Y, and at least one of Z.

The assemblies, apparatuses, and/or systems described herein are not limited to the specific embodiments described herein, but rather, components of the systems and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A camera housing, comprising:
an outer shell surrounding at least a portion of a camera, said outer shell including an aperture formed therethrough; and
a positional adjustment assembly coupled to said outer shell, said positional adjustment assembly including:
a hub component extending through the aperture of said outer shell;
a tilt plate coupled to and positioned adjacent a first end of said hub component, said tilt plate including at least one tilt feature; and
an adjustment component coupled to said hub component, between the first end and a second end of said hub component, said adjustment component selectively adjustable between a locked position and an unlocked position,
wherein said positional adjustment assembly is configured to adjust at least one of a height or an angular tilt of said outer shell in response to said adjustment component being in the unlocked position.

2. The camera housing of claim 1, wherein said positional adjustment assembly is positioned adjacent and contacts a single, support armature in the locked position.

3. The camera housing of claim 1, wherein said positional adjustment assembly further includes:
a cam component coupled to and positioned adjacent the second end of said hub component.

4. The camera housing of claim 3, wherein said adjustment component includes an end face having a first geometry, and said cam component includes an end face positioned adjacent the adjustment component end face, the cam component end face including a second geometry that is complimentary to the first geometry of said adjustment component in the unlocked position.

5. The camera housing of claim 1, wherein the at least one tilt feature of said tilt plate for said positional adjustment assembly further includes one of:
a plurality of fanned notches formed on a surface of said tilt plate, or
a curved notch formed on the surface of said tilt plate.

6. The camera housing of claim 1, further comprising a securing component coupled to said outer shell and extending toward said tilt plate of said positional adjustment assembly, said securing component configured to contact the at least one tilt feature of said tilt plate.

7. The camera housing of claim 1, wherein said adjustment component of said positional adjustment assembly includes an opening for receiving and circumferentially surrounding said hub component, between the first end and the second end.

8. The camera housing of claim 1, wherein said tilt plate of said positional adjustment assembly is disposed within an internal cavity defined by said outer shell, and said adjustment component of said positional adjustment assembly is disposed outside of the internal cavity.

9. The camera housing of claim 1, wherein said outer shell further includes:
a sidewall portion, the aperture extending through said sidewall portion;
a front portion releasably coupled to said sidewall portion; and
a back portion releasably coupled to said sidewall portion, opposite said front portion.

10. The camera housing of claim 1, wherein said positional adjustment assembly is configured to adjust the height and the angular tilt of said outer shell in response to said adjustment component being in the unlocked position.

11. A camera mount assembly, comprising:
a single, support armature including a slot formed through at least a portion of a sidewall;
a slidable mount disposed within said single, support armature, the slidable mount including a coupling portion extending through the slot of said single, support armature;
a chain coupled to said slidable mount and extending through said single, support armature; and
a camera housing coupled to the slidable mount, adjacent the single, support armature, said camera housing including:
an outer shell surrounding at least a portion of a camera, said outer shell including an aperture formed therethrough and aligned with the coupling portion of said slidable mount; and
a positional adjustment assembly coupled to said outer shell, said positional adjustment assembly including an adjustment component positioned adjacent said single, support armature and selectively adjustable between a locked position and an unlocked position,
wherein said positional adjustment assembly is configured to adjust at least one of a height or an angular tilt of said outer shell in response to said adjustment component being in the unlocked position.

12. The camera mount assembly of claim 11, wherein the coupling portion of said slidable mount is configured to selectively move within the slot of said single, support armature in response to adjusting the height of said outer shell.

13. The camera mount assembly of claim 11, wherein said chain includes a first end directly coupled to said slidable mount, the first end of said chain configured to selectively move within said single, support armature in response to adjusting the height of said outer shell.

14. The camera mount assembly of claim 11, wherein said positional adjustment assembly of said camera housing further includes:
a hub component extending through the aperture of said outer shell and coupled to the coupling portion of said slidable mount, said adjustment component coupled to said hub component, between a first end and a second end of said hub component;
a tilt plate coupled to and positioned adjacent the first end of said hub component, said tilt plate including at least one tilt feature; and
a cam component coupled to and positioned adjacent the second end of said hub component, said cam component positioned between said single, support armature and said adjustment component of said positional adjustment assembly.

15. The camera mount assembly of claim 14, wherein said adjustment component of said positional adjustment assembly for said camera housing includes an end face having a first geometry, and said cam component includes an end face positioned adjacent the adjustment component end face, the cam component end face including a second geometry that is complimentary to the first geometry of said adjustment component in the unlocked position.

16. The camera mount assembly of claim 14, wherein the at least one tilt feature of said tilt plate for said positional adjustment assembly further includes one of:
a plurality of fanned notches formed on a surface of said tilt plate, or
a curved notch formed on the surface of said tilt plate.

17. The camera mount assembly of claim 14, wherein said camera housing further comprises:
a securing component coupled to said outer shell and extending toward said tilt plate of said positional adjustment assembly, said securing component configured to contact the at least one tilt feature of said tilt plate.

18. The camera mount assembly of claim 14, wherein said adjustment component of said positional adjustment assembly for said camera housing includes an opening for receiving and circumferentially surrounding said hub component, between the first end and the second end.

19. A camera tower, comprising:
a base assembly including a bottom plate; and
a camera mount assembly coupled to said base assembly, said camera mount assembly including:
a single, support armature extending from said base assembly, said single, support armature including a slot formed through at least a portion of a sidewall;
a slidable mount disposed within said single, support armature, said slidable mount including a coupling portion extending through the slot of said single, support armature;
a chain coupled to said slidable mount and extending through said single, support armature; and
a camera housing coupled to said slidable mount, adjacent said single, support armature, said camera housing including:
an outer shell surrounding at least a portion of a camera, said outer shell including an aperture formed therethrough and aligned with said coupling portion of said slidable mount; and
a positional adjustment assembly coupled to said outer shell and including an adjustment component positioned adjacent said single, support armature of said camera mount assembly,
wherein said positional adjustment assembly is configured to adjust at least one of a height or an angular tilt of said outer shell in response to said adjustment component being in an unlocked position.

20. The camera tower of claim 19, wherein said camera mount assembly further includes a support plate coupled to said single, support armature opposite the slot formed through at least the portion of the sidewall, the support plate releasably coupled to the bottom plate of said base assembly.
